(19) United States
(12) Patent Application Publication
(10) Pub. No.: US 2022/0210561 A1
(43) Pub. Date: Jun. 30, 2022

(54) PORTABLE PURE STEREO MUSIC PLAYER, STEREO HEADPHONES, AND PORTABLE STEREO MUSIC PLAYBACK SYSTEM

(71) Applicant: Yui Hung LI, Kowloon (HK)

(72) Inventor: Yui Hung LI, Kowloon (HK)

(21) Appl. No.: 17/607,319

(22) PCT Filed: Feb. 21, 2020
(86) PCT No.: PCT/CN2020/076138

§ 371 Date: Oct. 28, 2021

(30) Foreign Application Priority Data
Apr. 29, 2019 (CN) 201910353974.0

(51) Int. Cl. H04R 5/04; H04R 5/033; H04R 1/10

(52) U.S. Cl. CPC H04R 5/04; H04R 2205/021; H04R 1/1091; H04R 5/033

(57) ABSTRACT

The portable stereo music playback system of the present invention includes a portable pure stereo music player and stereo earphones. The left and right channels of the player have two or more electronic frequency dividing(crossover) circuits respectively. The audio domain is continuously divided, and each electronic crossover circuit is output independently through a multi-contact connector. The earphone has a left-channel earphone and a right-channel earphone. There are the same number of driver units according to the numbers of electronic crossover circuits in the left and right channels of the player. Each driver (sounding) unit in the left-channel earphone and the right-channel earphone is connected to the player through an independent wire via a multi-contact connector, the left channel driver units and the right channel driver units in the earphone respectively play back the sound of the audio segments corresponding to the electronic crossover circuits of the left and right channels of the player.

### TECHNICAL FIELD

The present invention relates to a music playback device, and in particular to a portable pure stereo music player, stereo headphone, and a portable stereo music playback system.

### BACKGROUND TECHNIQUE

As shown in FIGS. 1(a) and (b), the existing portable pure stereo music player system is driven by left and right channel amplifiers (also called headphone amplifiers) to drive the drivers in the left and right channel earbud (including earphones) units to produce sound, and the player and earbuds rely on three wires (the common ground type portable pure stereo music playback system shown in FIG. 1(a)) or four wires (the balanced portable pure stereo music shown in FIG. 1(b) Playback system) connection, there are only two wires for each of the left and right channel earbuds to connect to the player. In order to enhance the performance of the earbuds, the manufacturer installs two or more drivers in each of the left and right earbuds, and some also install acoustic pipes for each driver as a filter. It is hoped that different drivers can be used to play different audio frequency bands, and hoped to improve the playback performance of earbuds. However, since the left and right channel earbuds each have only two wires connected to the player, all the drivers in each channel earbuds are connected in parallel, and each driver receives the same electrical signal and emits basically the same sound. The multiple drivers and the filters are difficult to achieve accurate frequency division and playback.

### SUMMARY OF THE INVENTION

The present invention is proposed to solve the above-mentioned problems, and its purpose is to provide a portable pure stereo music player, stereo earphones, and a portable stereo music playback system.

The present invention provides a portable pure stereo music player, which is characterized in that:

The left channel and the right channel of the portable pure stereo music player have two or more electronic frequency division (filter) circuits respectively, and these electronic frequency division circuits continuously divide the entire audio domain of each of the left channel and the right channel, And, each electronic frequency divider circuit outputs electric signal independently via a multi-contact connector.

In the present invention, a plurality of electronic frequency dividing circuits are used to continuously divide the entire audio domain of each of the left and right channels and then output them. As a result, the actual input to the earphone (or earbud) is continuously-frequency band audio signals, a true stereo playback will be achieved.

In addition, in the portable pure stereo music player of the present invention, there is also connected between the electronic frequency divider circuit and the multi-contact connector and is arranged correspondingly to each of the electronic frequency divider circuits. A plurality of amplifiers that amplify the output signal of the electronic frequency divider circuit.

According to the above-mentioned structure of the present invention, the output of each of the electronic frequency dividing circuits can be adjusted to a desired magnitude as required.

In addition, in the portable pure stereo music player of the present invention, each of the plurality of amplifiers is an amplifier with adjustable gain.

According to the above structure of the present invention, since the gain of each amplifier is adjustable, the output power of each output signal of the left and right channels can be adjusted as needed to achieve the desired listening effect.

In addition, in the portable pure stereo music player of the present invention, the multi-contact connector is a female connector.

In addition, the present invention provides a stereo headphone, which is characterized in that:

With left channel earphone and right channel earphone,
Two or more driver units are respectively provided in the left channel earphone and the right channel earphone, and each of driver units in the left channel earphone and the right channel earphone respectively passes through an independent wire is connected to the outside via a multi-contact connector, and each of the driver units in the left-channel earphone and the right-channel earphone respectively play a specific range of an audio segment.

In addition, in the stereo headphone of the present invention, the range of the audio segment played by each of the driver units in the left-channel headphone and the right-channel headphone is sequential and continuous.

According to the present invention, since each driver in the left-channel earphone and the right-channel earphone respectively receives mutually continuous audio with different frequencies, a true stereo listening effect is realized.

In addition, in the stereo earphone of the present invention, the left channel earphone and the right channel earphone are earbud earphones.

In addition, in the stereo headphone of the present invention, the multi-contact connector is a male connector.

In addition, the present invention provides a portable stereo music playback system, which is characterized in that:

The portable stereo music playing system includes a portable pure stereo music player and stereo earphones,
The left channel and the right channel of the portable pure stereo music player have two or more electronic frequency division circuits respectively, and these electronic frequency division circuits continuously divide the entire audio domain of each of the left channel and the right channel, Moreover, each electronic frequency divider circuit outputs independently via the first multi-contact connector,
The stereo earphone has a left channel earphone and a right channel earphone,
The left channel earphone and the right channel earphone are respectively provided with the same number of driver units as the number of the electronic frequency divider circuits of the left channel and the right channel of the portable pure stereo music player, each of driver units in the left-channel earphone and the right-channel earphone is connected to a second multi-contact connector through an independent wire,
The second multi-contact connector is a connector that matches the first multi-contact connector. By connecting the second multi-contact connector to the first multi-contact connector, the stereo headphoneis connected to the portable pure stereo music player completely.
Each of the driver units in the left-channel earphone and the right-channel earphone respectively play the audio segments corresponding to the electronic frequency dividers of the left and right channels of the portable pure stereo music player.

According to the portable stereo music playback system of the present invention, in the portable pure stereo music player, multiple electronic frequency dividers are used to continuously divide the entire audio domain of each of the left and right channels, and the corresponding audio electronic signal is output to each corresponding driver unit in the left-channel earphone and right-channel earphone, so as to realize true stereo playback.

In addition, in the portable stereo music playback system of the present invention, the first multi-contact connector is a female connector, and the second multi-contact connector is a male connector.

In addition, in the portable stereo music playback system of the present invention, the left-channel earphone and the right-channel earphone are earbud earphones.

### DESCRIPTION OF THE DRAWINGS

FIG. 1(a) is a diagram showing an existing common ground type portable pure stereo music playback system, and (b) is a diagram showing an existing balanced type portable pure stereo music playback system.

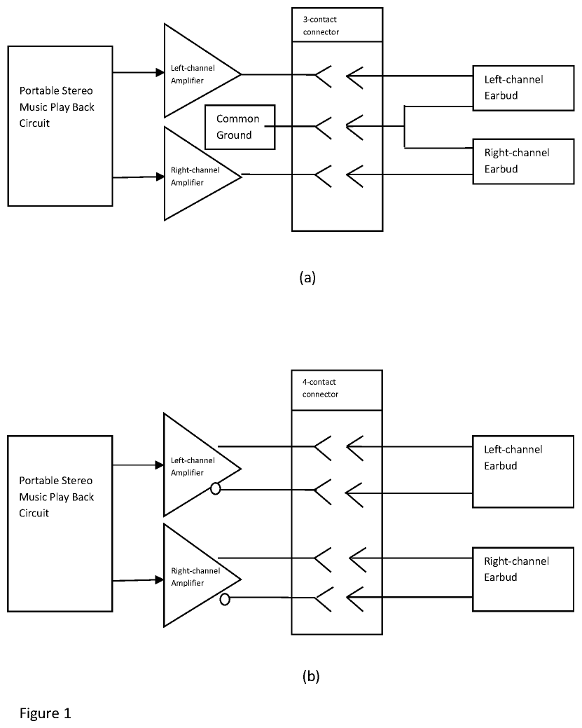

FIG. 2 is a diagram of a 3-way portable pure stereo music playback system using the present invention.

FIG. 3 is a diagram of another example of a 3-way portable pure stereo music playback system using the present invention.

FIG. 4 is a diagram of a 6-way crossover portable pure stereo music playback system using the present invention.

### DETAILED WAYS

Hereinafter, embodiments of the present invention will be described with reference to the drawings.

First, a brief introduction is made to the current status of the portable pure stereo music playback system. There are many stereo earbuds with multiple drivers on the market. Some earbuds have more than 10 drivers in each of the left and right channels, claiming that multiple drivers can improve the performance of the earbuds. However, the actual effect is far from being achieved. The reason is that each of the left and right channel earbuds has only two wires connected to the player. All the driver units in the left and right channel earbuds are connected in parallel, and all the driver units receive the same electric signal, therefore, the sound produced is basically the same, which is similar to the case of using only one driver unit.

The invention of this application is to add two or more electronic frequency division circuit to the left and right channels on a portable pure stereo music player. The frequency of each electronic frequency division circuit is coherent but independent of each other. , That is, the output audio of the left channel is divided by multiple (ie, more than two) electronic frequency dividers, so as to output multiple audio electronic signal with different but continuous frequencies. In addition, there can be separated gain controls, each frequency divider circuit has an independent circuit to output through the multi-contact connector, these are the same for the right channel, in addition, the multi-contact connector usually used in the player is a female connector. Two or more driver units with different frequency response characteristics corresponding to each electronic frequency divider circuit in the portable pure stereo music player are arranged in the earphone used with the portable pure stereo music player. (Or unit group) Use separate wires to connect to the multi-contact connector. Usually, the multi-contact connector used by the headphone is a male connector. When in use, the multi-contact connector of the earphone is inserted into the multi-contact connector of the player to connect the two. The multi-contact connector of the headphone and the multi-contact connector of the player correspond in frequency. How many electronic crossover circuits are in the player, and how many driver units of different frequency bands are in the headphone. Each driver (or unit group) receives the electric signal of the corresponding frequency band and the strength is controllable, and emits the sound of the corresponding frequency band. In addition, the aforementioned earphones may also be earbud earphones.

How many frequency division output circuits are there on the player of the portable pure stereo music playback system of the invention of the present application, and there will be how many drivers in the earphone corresponding to the frequency division output circuits there are in the player, they are in matched frequency bands, each driver is connected to the circuit output end of the corresponding frequency band of the player with an independent wire via a multi-contact connector.

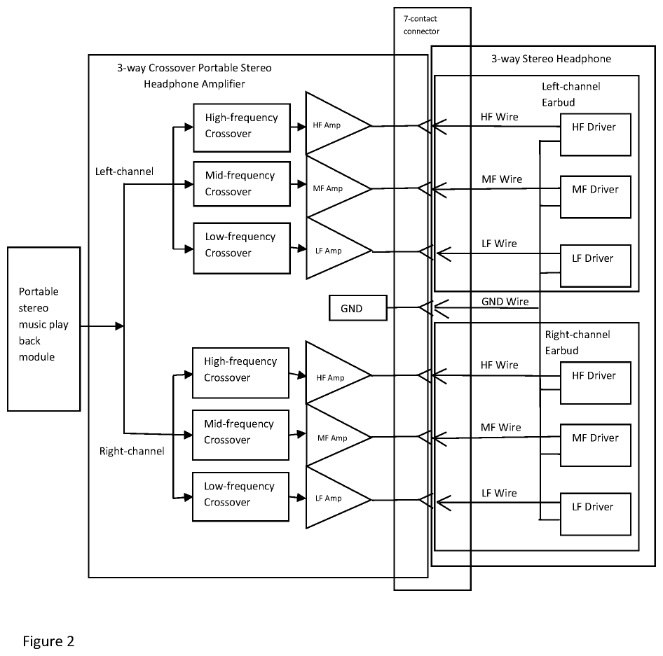

FIG. 2 shows the case of a 3-way portable pure stereo music playback system. Specifically, in the portable pure stereo music playback system shown in FIG. 2, the output of the player is a common ground, and the player has three electronic frequency dividers on the left channel to perform high-frequency, middle-frequency division and low frequency division on the left channel audio frequency band, and respectively output the electronic signal of high frequency, intermediate frequency and low frequency bands. In addition, the high frequency, intermediate frequency and low frequency amplifiers are used to amplify the divided electronic signals of the high frequency, intermediate frequency and low frequency bands. The output of the high-frequency amplifier, intermediate-frequency amplifier, and low-frequency amplifier can be output to the outside through the 7-contact connector of the player, that is, the output of the high-frequency amplifier, intermediate-frequency amplifier, and low-frequency amplifier are connected to the 7-contact connector (the connector is Female connector), in the case shown in FIG. 2, the 7-contact connector of the player is connected to the 7-contact connector of the headphone (correspondingly, the connector is a male connector) and the left channel of the player is connected to the left-channel earphone, and the high-frequency, intermediate-frequency, and low-frequency output from the high-frequency amplifier, intermediate-frequency amplifier, and low-frequency amplifier are respectively output to the high-frequency drivers (or unit group), the intermediate-frequency drivers (or unit group) and low-frequency drivers (or unit group)of the left-channel earphone. In addition, with regard to the right channel, as in the case of the left channel, the player has three electronic crossover circuits on the right channel, output high-frequency, intermediate-frequency and low-frequency electronic signals. In addition, high-frequency amplifier, intermediate-frequency amplifier and low-frequency amplifier are used to amplify the divided high-frequency, intermediate-frequency and low-frequency electronic signals. The output of the amplifier can be output to the outside via the above 7-contact connector, that is, the outputs of the high-frequency amplifier, intermediate frequency amplifier, and low-frequency amplifier are connected to the above 7-contact connector. In the case shown in FIG. 2, it is 7-contact connector of the player, is connected to the 7-contact connector of the earphone, the right channel of the player is connected to the right channel earphone, and the high-frequency, intermediate-frequency, and low-frequency electronic signals are output by the high-frequency amplifier, intermediate-frequency amplifier, and low-frequency amplifier are respectively to the high-frequency drivers (or unit group), the middle-frequency drivers (or unit group), and the low-frequency drivers (or unit group) of the right channel earphone.

In addition, as shown in FIG. 2, corresponding to a 3-way portable pure stereo music player, a 3-way stereo earphone includes a left-channel earphone and a right-channel earphone. The left channel earphone correspondingly has a high-frequency driver (or unit group), an intermediate-frequency driver (or unit group), and a low-frequency driver (or unit group). The high-frequency driver (or unit group), the intermediate frequency driver (or unit group),the low-frequency driver (or unit group) are connected to the 7-contact connector of the earphone, through the high-frequency wire, the intermediate frequency wire, and the low-frequency wire, whereby the high-frequency, mid-frequency and low-frequency electric signals from the left channel of the 3-way portable pure stereo music player are connected through the 7-contact connector of the player and the matched 7-contact connector of the earphone. The amplifiers' high-frequency, mid-frequency and low-frequency electric signals are respectively output to the high-frequency drivers (or unit group), mid-frequency drivers (or unit group), and low-frequency drivers (or unit group) of the left channel earphone. Similarly, the right-channel earphone has a high-frequency driver (or unit group), an intermediate-frequency driver (or unit group), and a low-frequency driver (or unit group) are correspondingly connected to the right channel of the player, via the 7-contact connector of the earphone, the high-frequency driver (or Unit group) is connected to the 7-contact connector of the earphone through the high-frequency wire, the intermediate frequency driver is connected to the 7-contact connector of the earphone through the intermediate frequency wire, the low-frequency drivers (or unit group) is connected to the 7-contact connector of the earphone through the low-frequency wire, so that the high-frequency, mid-frequency and low-frequency electric signal from the right channel of the 3-way portable pure stereo music player passes through the 7-contact connector of the player, to the 7-contact connector of the matching earphone are respectively output to the high-frequency driver (or unit group), mid-frequency driver (or unit group) and low-frequency driver (or unit group) of the right channel earphone. In addition, FIG. 2 shows a common ground connection, that is, the ground wires of the high-frequency drivers (or unit group), the middle-frequency drivers (or unit group) and the low-frequency drivers (or unit group) of the left-channel earphone and the right-channel earphone are connected together on the 7-contact connector of the headphone. In addition, when the 7-contact connector of the 3-way stereo headphone is connected to the 7-contact connector of the player, the above-mentioned common ground wire connect to the common ground terminal of the 7-contact connector of the player. In addition, a 3-way stereo headphone is shown in FIG. 2, but it is not limited to this, and of course it may be earbuds (earbud-style earphones) or the like.

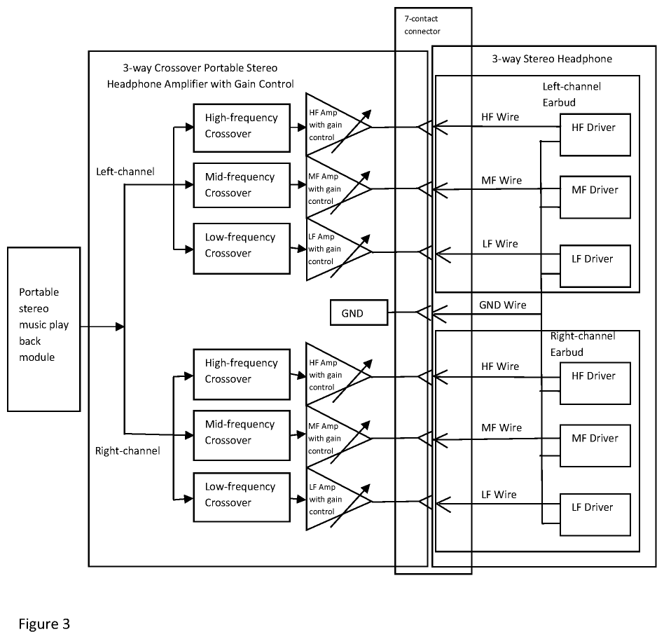

In addition, another example of a 3-way portable pure stereo music playback system is shown in FIG. 3, that is, a 3-way portable pure stereo music playback system with gain control. Specifically, in FIG. 3, the gains of the high-frequency amplifier, intermediate-frequency amplifier, and low-frequency amplifier of the left and right channels are independently controllable, that is, each of the high-frequency amplifier, intermediate-frequency amplifier, and low-frequency amplifier can be independently adjusted in order to achieve a better listening effect, the other structures in FIG. 3 are the same as those in FIG. 2.

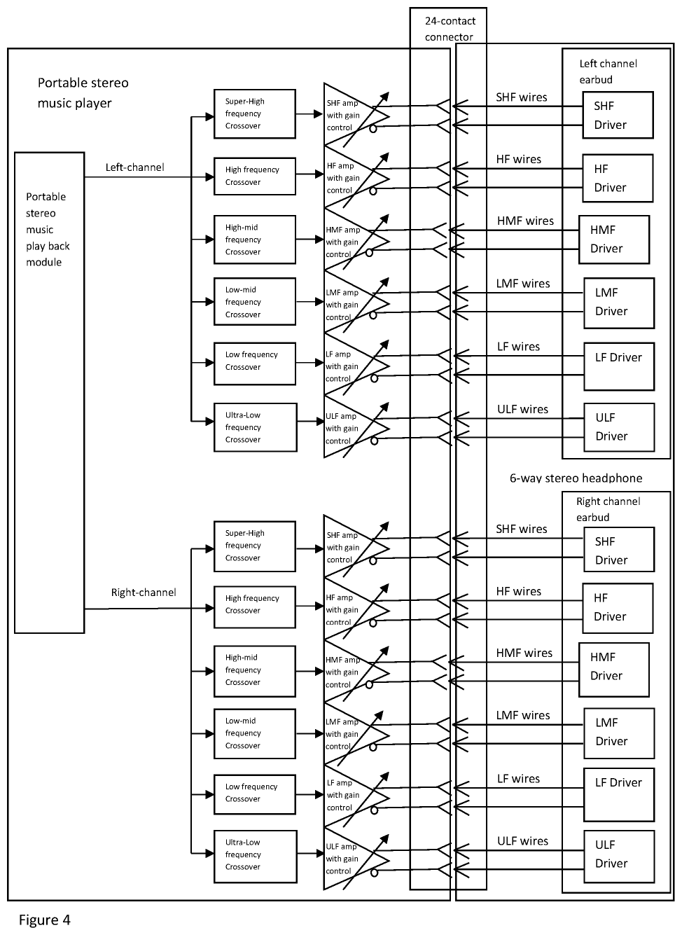

In addition, FIGS. 4a & 4b shows a portable pure stereo music playback system with 6 electronic crossovers, adjustable gain, and balanced output. As shown in FIGS. 4a & 4b, a player and a 6-way stereo earphone are using a 24-contact connector pair, that means that the female 24-contact connector (female connector) of the player and the male 24-contact connector (male connector) of the 6-way stereo earphone are connected to each other. Specifically, in the portable pure stereo music playback system shown in FIGS. 4a & 4b, the player has six electronic crossover circuits on the left channel to perform ultra-high frequency division, high-frequency division, high-mid frequency division, low-mid frequency division, low frequency division, and ultra-low frequency division, and respectively output the electric signal of super-high frequency, high frequency, high-mid frequency, low-mid frequency, low frequency and ultra-low frequency. In addition, super-high frequency amplifier, high frequency amplifier, High-intermediate frequency amplifier, low-intermediate frequency amplifier, low-frequency amplifier, and ultra-low frequency amplifier to amplify the divided frequency in the super-high frequency, high frequency, high-mid frequency, low-mid frequency, low frequency and ultra-low frequency bands. The output of the super-high frequency amplifier high frequency amplifier, high-intermediate frequency amplifier, low-intermediate frequency amplifier, low frequency amplifier and ultra-low frequency amplifier can be output to the outside through the 24-contact connector, namely, the output of the super-high frequency amplifier, high frequency amplifier, high-intermediate frequency amplifier, low-intermediate frequency amplifier, low frequency amplifier, ultra-low frequency amplifier is connected to a 24-contact connector (the connector here is a female connector). In the case shown in FIGS. 4a & 4b, it is the 24-contact connector of the player and the 24-contact connector of the earphone (correspondingly, The 24-contact connector of the earphone is a male connector) to connect the left channel of the player to the left channel earphone, and, the electric signal of super-high frequency amplifier, high frequency amplifier, high-intermediate frequency amplifier, low-intermediate frequency amplifier, low frequency amplifier, ultra-low frequency amplifier are respectively output to the super-high frequency driver, high frequency driver, high-intermediate frequency driver, low-intermediate frequency driver, low frequency driver, ultra-low frequency driver unit of the left channel earphone. In addition, with regard to the right channel, as in the case of the left channel, the player has six electronic crossover circuits on the right channel to perform super-high frequency, high-frequency, high-mid frequency, and high-frequency division on the right channel, and respectively output the electric signal of super-high frequency, high frequency, high-mid frequency, low-mid frequency, low frequency and ultra-low frequency. In addition, super-high frequency amplifier, high frequency amplifier, High-intermediate frequency amplifier, low-intermediate frequency amplifier, low-frequency amplifier, and ultra-low frequency amplifier to amplify the divided frequency in the super-high frequency, high frequency, high-mid frequency, low-mid frequency, low frequency and ultra-low frequency bands. The output of the super-high frequency amplifier, high frequency amplifier, high-intermediate frequency amplifier, low-intermediate frequency amplifier, low frequency amplifier and ultra-low frequency amplifier can be output to the outside through the 24-contact connector, namely, the output of the super-high frequency amplifier, high frequency amplifier, high-intermediate frequency amplifier, low-intermediate frequency amplifier, low frequency amplifier, ultra-low frequency amplifier is connected to a 24-contact connector (the connector here is a female connector). In the case shown in FIGS. 4a & 4b, it is the 24-contact connector of the player and the 24-contact connector of the earphone to connect the right channel of the player to the right channel earphone, and, the electric signal of super-high frequency amplifier, high frequency amplifier, high-intermediate frequency amplifier, low-intermediate frequency amplifier, low frequency amplifier, ultra-low frequency amplifier are respectively output to the super-high frequency driver, high frequency driver, high-intermediate frequency driver, low-intermediate frequency driver, low frequency driver, ultra-low frequency driver unit of the right channel earphone. In addition, as shown in FIGS. 4a & 4b, the super-high frequency amplifiers, high frequency amplifiers, high-intermediate frequency amplifiers, low-intermediate frequency amplifiers, low frequency amplifiers, ultra-low frequency amplifiers of the left and right channels can be amplifiers with adjustable gain, that is, The gains of super-high frequency amplifier, high frequency amplifier, high-intermediate frequency amplifier, low-intermediate frequency amplifier, low frequency amplifier, ultra-low frequency amplifier can be adjusted independently to achieve the purpose of wanted better listening effect.

In addition, as shown in FIGS. 4a & 4b, corresponding to a 6-way portable pure stereo music player, a 6-way stereo earphone (6-way stereo headphone) includes a left channel earbud and a right channel earbud, and the left channel earphone, correspondingly with the left channel player, has a super-high frequency driver, a high frequency driver, a high-intermediate frequency driver, a low-intermediate frequency driver, a low frequency driver and an ultra-low frequency driver. The super-high frequency driver, the high frequency driver, the high-intermediate frequency driver, the low-intermediate frequency driver, the low frequency driver and the ultra-low frequency driver respectively pass through the super-high frequency wire, high frequency wire, high-intermediate frequency wire, low-intermediate frequency wire, low frequency wire and the ultra-low frequency wire and connected to the 24-contact connector of the earphone, so that the super-high frequency, the high frequency, the high-intermediate frequency, the low-intermediate frequency, the low frequency and the ultra-low frequency segments' electric signal from the left channel of the 6-way portable stereo music player are output to the super-high frequency driver, the high frequency driver, the high-intermediate frequency driver, the low-intermediate frequency driver, the low frequency driver and the ultra-low frequency driver of the left channel earphone through the 24-contact connector of the driver and the matched 24-contact connector of the earphone. Similarly, the right channel earphone, correspondingly with the right channel player, has a super-high frequency driver, a high frequency driver, a high-intermediate frequency driver, a low-intermediate frequency driver, a low frequency driver and an ultra-low frequency driver. The super-high frequency driver, the high frequency driver, the high-intermediate frequency driver, the low-intermediate frequency driver, the low frequency driver and the ultra-low frequency driver respectively pass through the super-high frequency wire, high frequency wire, high-intermediate frequency wire, low-intermediate frequency wire, low frequency wire and the ultra-low frequency wire and connected to the 24-contact connector of the earphone, so that the super-high frequency, the high frequency, the high-intermediate frequency, the low-intermediate frequency, the low frequency and the ultra-low frequency segments' electric signal from the left channel of the 6-way portable stereo music player are output to the super-high frequency driver, the high frequency driver, the high-intermediate frequency driver, the low-intermediate frequency driver, the low frequency driver and the ultra-low frequency driver of the left channel earphone through the 24-contact connector of the driver and the matched 24-contact connector of the earphone.

In addition, in the structure shown in FIGS. 4a & 4b, the left-channel earbud and the right-channel earbud are connected to the player through the 24-contact connector of the earphone and the 24-contact connector of the player, forming a balanced playback. In the system, the 24-contact connector of the player and the 24-contact connector of the earphone are matched pair. In addition, the aforementioned left-channel earphone and right-channel earphone may be earbud headphones.

In addition, the structures shown in FIGS. 2 to 4 are only embodiments of the present invention. In fact, for the left and right channels of the player, it is not limited to three or six electronic frequency dividing circuits, but can be based on It is actually necessary to determine the number of electronic frequency-dividing circuits. Of course, correspondingly, the number of driver units in the left and right channel earphones must be the same as the number of electronic frequency-dividing circuits provided for the left and right channels of the player. In addition, the connector can be selected according to the actual situation, that is, the number of its contacts can be determined according to the situation. In addition, in the above-mentioned embodiment, the number of electronic crossover circuits provided on the left channel and the right channel is the same, and of course they can also be different. However, in order to have a better listening effect, it is preferable to use same number of electronic frequency divider circuits in the left channel and the right channel.

The present invention has been described with examples given above, but the present invention is not limited to these, and various modifications can be made without departing from the spirit of the present invention.

1. A portable pure stereo music player, characterized in that the left channel and the right channel of the portable pure stereo music player have two or more electronic frequency dividing(crossover) circuits respectively, and these electronic frequency dividing circuits divide the entire audio domain of each of the left and right channels into continuously segments, and each electronic crossover circuit is independently output via a multi-contact connector.

2. The portable pure stereo music player according to claim 1, characterized in that it further has a amplifier circuit placed between the electronic frequency divider circuit and the multi-contact connector, and corresponds to each of the electronic frequency divider circuits, a plurality of amplifiers which are arranged to amplify the output of the electronic frequency divider circuit.

3. The portable pure stereo music player according to claim 2, wherein each of the plurality of amplifiers is an amplifier with adjustable gain.

4. The portable pure stereo music player of claim 1, wherein the multi-contact connector is a female connector.

5. A stereo earphone, characterized by having a left channel earphone and a right channel earphone, two or more driver units are respectively arranged in the left channel earphone and the right channel earphone, so each of the driver unit in the left-channel earphone and the right-channel earphone is connected to the outside via a multi-contact connector through independent wires. Each of the driver unit respectively plays a specific range of the audio segment.

6. The stereo earphone according to claim 5, wherein the range of the audio segment played by each of the driver unit in the left channel earphone and the right channel earphone is sequential and continuous.

7. The stereo earphone of claim 5, wherein the left channel earphone and the right channel earphone comprise earbud earphones.

8. The stereo headphone of claim 5, wherein the multi-contact connector is a male connector.

9. A portable stereo music playback system, characterized in that the portable stereo music playback system comprises a portable pure stereo music player and stereo earphones, and the left and right channels of the portable pure stereo music player respectively have Two or more electronic frequency dividing circuits, which continuously divide the entire audio domain of the left and right channels, and each electronic frequency dividing circuit independently outputs via the first multi-contact connector The stereo earphone has a left channel earphone and a right channel earphone. The left channel earphone and the right channel earphone are respectively provided same number drivers according to the numbers of electronic frequency divider circuit in the left channel and the right channel of the portable pure stereo music player. And each of the driver unit in the left-channel earphone and the right-channel earphone is connected to a second multi-contact connection through an independent wire. The second multi-contact connector is a connector that matches the first multi-contact connector. By connecting the second multi-contact connector to the first multi-contact connector, the Stereo earphones are connected to the portable pure stereo music player, and each of the driver unit in the left-channel earphone and the right-channel earphone respectively play back the corresponding audio segment of electric signal from the left and right channels of the portable pure stereo music player.

10. The portable stereo music playback system of claim 9, wherein the first multi-contact connector is a female connector, and the second multi-contact connector is a male connector.

11. The portable stereo music playback system of claim 9, wherein the left-channel earphone and the right-channel earphone comprise earbud headphones.

12. The portable pure stereo music player of claim 2, wherein the multi-contact connector is a female connector.

13. The portable pure stereo music player of claim 3, wherein the multi-contact connector is a female connector.

14. The stereo earphone of claim 6, wherein the left channel earphone and the right channel earphone comprise earbud earphones.

15. The stereo headphone of claim 6, wherein the multi-contact connector is a male connector.

16. The stereo headphone of claim 7, wherein the multi-contact connector is a male connector.

17. The portable stereo music playback system according to claim 10, wherein the left-channel earphone and the right-channel earphone comprise earbud headphones.
